(19) United States
(12) Patent Application Publication
(10) Pub. No.: US 2013/0043275 A1
(43) Pub. Date: Feb. 21, 2013

(54) HOT-WATER WATERING DEVICE FOR REMOVING WEEDS

(71) Applicant: Jeffrey Ayers Smith, Pompano Beach, FL (US)

(72) Inventor: Jeffrey Ayers Smith, Pompano Beach, FL (US)

(21) Appl. No.: 13/212,186

(22) Filed: Aug. 18, 2011

(51) Int. Cl. B67D 7/80

(52) U.S. Cl. 222/146.5; 239/152

(57) ABSTRACT

The present invention discloses a hot-water watering device for removing weeds, and the device comprises a movable main body having a roller set and a push-pull handle, and a water outlet module, such that a battery set installed in the main body and an electric power of the battery set are provided for a heating device to heat liquid water to an appropriate high temperature, and then the hot water is watered directly and accurately at roots of the desired removing weeds through a water outlet module, so as to achieve an expected weeds removing performance.

### BACKGROUND OF THE INVENTION

1. Fields of the Invention

The present invention relates to a hot-water watering device for removing weeds, and more particularly to a device that uses hot water to substitute chemicals in an operation of watering the weeds by hot water to remove the weeds simply and easily, so as to achieve an excellent-performance environmental protection effect.

2. Description of the Related Art

Removing weeds is a disturbing and tedious job for most people. Besides the problems of the fast-growing height and the tenacious vitality of the weeds, people also have to face the problem of such a time-consuming, laborious, and ineffective lawn-mowing job helplessly. Of course, we can use chemicals to achieve an immediate weeding effect. However, the chemicals of this sort are severely harmful to both of the environment and living organisms and the chemicals also cause a well-known serious complication. Therefore, if ecological and environmental protection related issues are taken into consideration, we really should realize the aforementioned problem as early as possible and try not to adopt extreme measures which are absolutely unfavorable to our environment. Just as most people experience, we are trapped in a dilemma and tormented by the difficulty of eradicating or cleaning up the weeds.

### SUMMARY OF THE INVENTION

In view of the aforementioned problems, the inventor of the present invention bases on the consideration of ecological maintenance and environmental protection to conduct extensive researches and experiments, and finally developed a hot-water watering device for removing weeds in accordance with the present invention, and the device is a convenient movable device that simply uses pure and harmless hot water to water weeds, so as to achieve the effect of removing the weeds effectively. The invention will not affect the plants nearby or jeopardize our environment and ecological situation. Therefore, it is primary objective of the present invention to provide a convenient and environment friendly device for removing weeds.

To achieve the foregoing objective, the present invention provides a hot-water watering device for removing weeds, and the device comprises a movable main body having a roller and a push-pull handle, and a water outlet module, such that a battery set installed in the main body and an electric power of the battery set are provided for a heating device to heat water to an appropriate high temperature, and then the hot water is watered directly and accurately to roots of the desired removing weeds through a water outlet module, so as to achieve an expected weeds removing performance.

### BRIEF DESCRIPTION OF THE DRAWINGS

The accomplishment of this and other objects of the invention will become apparent from the following description and its accompanying drawings of which:

FIG. 1 is a schematic perspective view of a preferred embodiment of the present invention;

FIG. 2 is a schematic perspective view of another preferred embodiment of the present invention; and

FIG. 3 is a schematic perspective view of a further preferred embodiment of the present invention.

### DETAILED DESCRIPTION OF THE PREFERRED EMBODIMENT

The technical measures and characteristics of the present invention will become apparent with the detailed description of preferred embodiments accompanied with related drawings as follows:

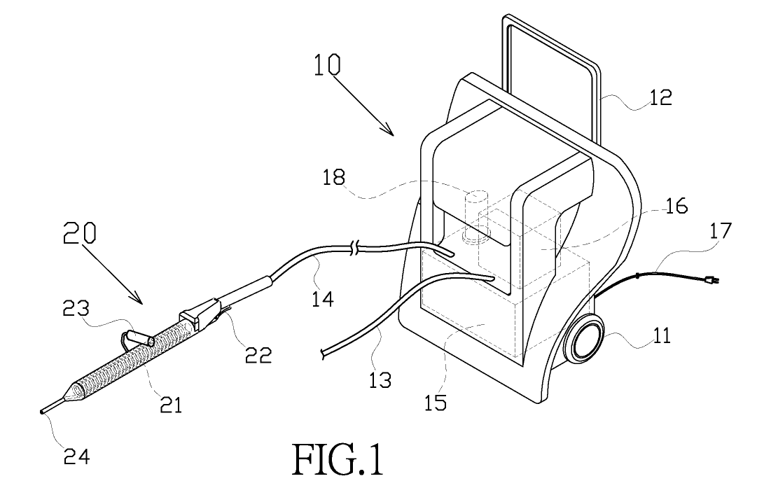

With reference to FIG. 1 for a preferred embodiment of the present invention, the invention comprises:

a movable main body 10, having a roller set 11, a push-pull handle 12, an inlet pipeline 13 and an outlet pipeline 14 installed outside the main body 10, and a water tank 15 and a chargeable battery set 16 installed in the main body 10; and a water outlet module 20, interconnected to the outlet pipeline 14 of the main body 10, and having a heating coil 21 installed in the water outlet module 20, such that the battery set 16 installed in the main body 10 supplies an electric power to the heating coil 21, and a press switch 22, a grip 23 and a water outlet end 24 installed outside the water outlet module 20.

With the aforementioned components, after the press switch 22 is turned on, a water supply and the power of the heating coil 21 are turned on at the same time, such that the hot water heated by the heating coil 21 can flow out from the water outlet end 24 to accurately water the roots of the desired removing weeds (not shown in the figure), so as to achieve the expected weeds removing performance.

To supply the electric energy effectively, the present invention further comprises an external power cable 17 installed at the main body 10 for supplying the required electric power and charging the battery set 16 continuously. Further, the invention can add a pressure pump 18 installed in the main body 10, such that the water in the water tank 15 can be delivered to the water outlet module 20 successfully.

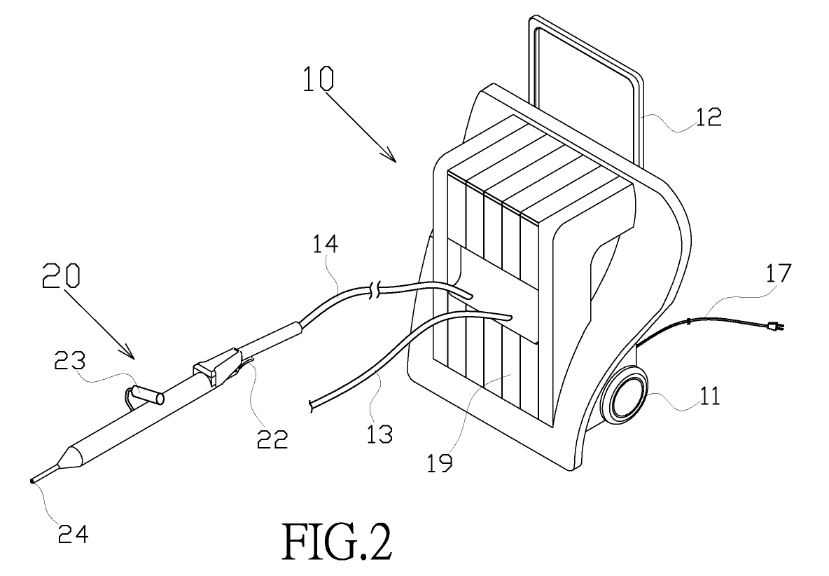

With reference to FIG. 2 for another preferred embodiment, a solar panel 19 is installed around the external periphery of the main body 10 for collecting solar energy and converting the solar energy into electric energy to be stored in the battery set 16, so as to maximize the utility of natural resources and the effect of environmental protection.

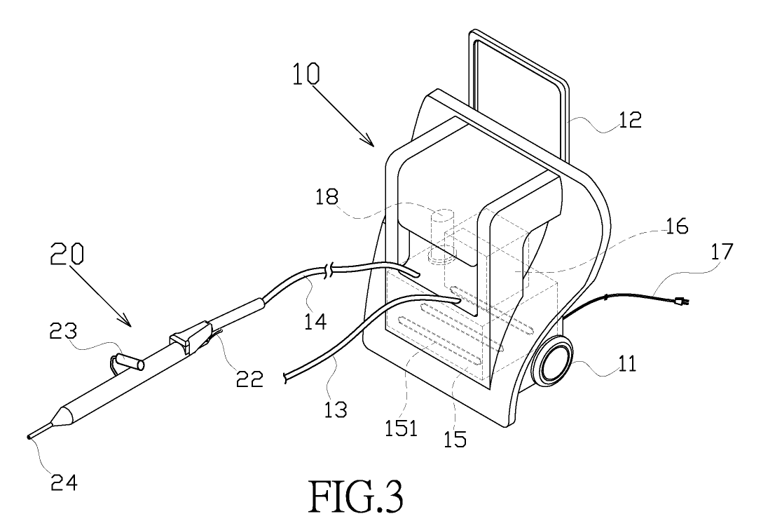

With reference to FIG. 3 for another preferred embodiment of the present invention, an electric heating pipe 151 is installed additionally in the water tank 15 for heating the water in the water tank 15, so as to enhance the heating efficiency.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A hot-water watering device for removing weeds, comprising:
a movable main body, having a roller set and a push-pull handle;
a water outlet module,
a battery set, installed in the main body, for supplying an electric power; and
a heating device, for heating liquid water to an appropriate high temperature;
whereby the water outlet module is used to water the hot water directly and accurately at roots of the desired removing weeds, so as to achieve an expected weeds removing performance.

2. A hot-water watering device for removing weeds, comprising:
a movable main body, having a roller set, a push-pull handle, an inlet pipeline and an outlet pipeline installed outside the main body, and a water tank and a chargeable battery set installed in the main body; and
a water outlet module, interconnected to the outlet pipeline of the main body, and having a heating coil installed in the water outlet module, such that the battery set installed in the main body supplies an electric power to the heating coil, and a press switch, a grip and a water outlet end installed outside the water outlet module;
whereby, after the press switch is turned on, a water supply is turned on and an electric power supply of the heating coil is turned on at the same time, so that the hot water heated by the heating coil can flow out from the water outlet end.

3. The hot-water watering device for removing weeds as recited in claim 2, wherein the main body includes an external power cable installed thereon.

4. The hot-water watering device for removing weeds as recited in claim 2, wherein the main body includes a pressure pump installed therein.

5. The hot-water watering device for removing weeds as recited in claim 2, wherein the water tank includes an electric heating pipe installed therein.
